(19) United States
(12) Patent Application Publication
(10) Pub. No.: US 2015/0121287 A1
(43) Pub. Date: Apr. 30, 2015

(54) SYSTEM FOR GENERATING AND CONTROLLING A VARIABLY DISPLAYABLE MOBILE DEVICE KEYPAD/VIRTUAL KEYBOARD

(71) Applicant: Yoram BEN-MEIR, Givataim (IL)

(72) Inventor: Israel FERMON, Jerusalem (IL)

(21) Appl. No.: 14/584,789

(22) Filed: Dec. 29, 2014

Related U.S. Application Data
(63) Continuation-in-part of application No. 12/046,800, filed on Mar. 12, 2008, now Pat. No. 8,959,441.
Application No. 12/046,800 is a continuation-in-part of application No. PCT/IL2007/000819, filed on Jul. 2, 2007.

(30) Foreign Application Priority Data
Jul. 3, 2006 (IL) 176673

(51) Int. Cl. G06F 3/0488; G06F 3/0484

(52) U.S. Cl. CPC G06F 3/04886; G06F 3/0484
USPC 715/773

(57) ABSTRACT

A system for generating and controlling a variably displayable virtual keypad includes a mobile device with a screen on which is displayable selected content, holographic projectors, from image generating data retrievable from a memory, a virtual keypad appearing to be free-floating and suspended in mid-air. An input identification unit identifies a virtual key pressing operation performed in conjunction with the generated virtual keypad, determining which key of the virtual keypad has been virtually pressed, and transmitting an input command in response to the virtual key pressing operation by which the displayed content is modifiable. The input identification unit includes a 3D camera capturing gestures of a user hand and transmitting a signal indicative of gesture related data to a microprocessor for translating the gesture related data into the input command by instructions stored in the memory device. The microprocessor generates feedback in response to the virtual key pressing operation to indicate which key has been virtually pressed and to modify a visualization parameter of the generated virtual keypad. The feedback may be in the form of an ultrasonic beam propagatable to the initiating finger.

This application is a continuation-in-part of U.S. patent application Ser. No. 12/046,800 filed Mar. 12, 2008 and entitled A VARIABLY DISPLAYABLE MOBILE DEVICE KEYBOARD, now US 2008/301575 which is a continuation-in-part application of International Patent Application No. PCT/IL2007/000819 filed Jul. 2, 2007 and entitled A VARIABLY DISPLAYABLE MOBILE DEVICE KEYBOARD, which claims priority from Israeli Patent Application No. 176673 filed Jul. 3, 2006 and entitled A VARIABLY DISPLAYABLE MOBILE DEVICE KEYBOARD.

### FIELD OF THE INVENTION

The present invention relates to the field of alphanumeric input devices. More particularly, the invention relates to a system for generating and controlling a variably displayable virtual keypad.

### BACKGROUND OF THE INVENTION

Mobile devices operable in various wireless networks, such as a cellular phone, are being provided with a larger memory, a stronger and faster processor, and with an increasing number of data services that can be performed thereby, such as messaging, e-mail transmission, gaming and more services.

The computing power of mobile devices is steadily increasing. Smart mobile devices perform many of the functions currently performed by laptop computers. Such a transition has been spurred by stronger and faster central processing units, larger memory, more sophisticated and capable operating systems, new generations of wireless network infrastructures including UMTS/HSDPA/LTE and WiFi, and an increasing penetration rate of data services such as messaging, e-mail, and gaming, despite restrictions of mobility, namely size, weight and battery life.

Even though the touchscreen of smart mobile devices has been steadily increasing in surface area during recent years, being accompanied by a corresponding increase in resolution, the size of these mobile devices is nevertheless limited so as to be graspable by the human palm and insertable in one's pocket. Thus the majority of mobile devices use a traditional phone keypad (such as in the widespread Android touchscreen keyboard), which is inadequate for new smart mobile devices and the corresponding applications. A more efficient alphanumeric input would therefore be desirable.

Modern smartphone have advanced capabilities, driven by more advanced Processors, Displays, Sensors, Batteries, Web connectivity, Materials, Operating Systems, and Networking Infrastructures (4G and beyond).

However, the existing User Interface (UI) is still limited by the physical size of the mobile devices. Thus much effort of smartphones developers is mainly focused on enhancing the user experience, which is affected by the type of UI that is offered to the user.

The high resolution and processing power available to smart mobile devices are usually not fully utilized due to the conventional layout of the keypad or other user interface, which occupy touchscreen space and detract from the user experience that would be normally available if the entire surface area of the keypad were used, or if the size of the keypad would exceed the physical dimensions of the mobile device.

It would therefore be desirable to provide means for causing the keypad to exceed the physical dimensions of the mobile device (which normally limits the size of the keypad) and to appear to be a virtual keypad that is suspended in mid-air and spaced from the mobile device's screen, to allow a user to benefit from a high quality data service that would become available once the keypad is larger while the entire surface area of the screen is viewable and not covered by the keypad.

Augmented reality technology is currently used in devices as virtual means for receiving inputs from the user by adding virtual keys or buttons to the viewed content, which the user can select and activate. However, this technology is mainly directed to optical devices such as cameras and not to smartphones, in which numeric and alphanumeric inputs are massively used by their running applications.

Augmented reality systems, usually in conjunction with a head mounted display, inject virtual objects into an image stream in real-time, to make the virtual objects that are not actually present in the real scene imaged by a camera, normally a 3D camera, to appear as real-life objects in the real surroundings of the user. At times the virtual objects are injected in response to location or context based stimuli.

The injection of virtual objects by augmented reality systems is generally carried out by means of a 3D camera, and not by a mobile device, which runs many applications other than photographing. Input commands of the user are received by gesture recognition. Following an input, a virtual object appears and blocks the field of view of the user who is interested in capturing a real-life object, to urge the user in making another interactive gesture-based input. The virtual object disappears after an input is made. The sudden appearance of the virtual object that blocks the user's field of view is very annoying and significantly reduces the speed in capturing objects of interest.

It is an object of the present invention to provide a variably displayable mobile device keypad which exceeds the physical dimensions of the mobile device.

It is an additional object of the present invention to provide a system for causing the keypad to appear to be suspended in mid-air and spaced from the mobile device's screen.

It is an additional object of the present invention to provide a system for causing the keypad to appear to be suspended in mid-air without blocking the mobile device's screen.

It is an additional object of the present invention to provide a variably displayable keypad in which, for example, all keys display letters in one mode and in another mode, all keys display numerals.

It is an additional object of the present invention to provide a variably displayable keypad in which the displayed area of the keys can be changed.

It is yet an additional object of the present invention to provide a keypad display which displays a stable image of key arrangement.

It is yet an additional object of the present invention to provide a keypad display that may be comfortably viewed.

Other objects and advantages of the invention will become apparent as the description proceeds.

### SUMMARY OF THE INVENTION

The present invention provides a system for generating and controlling a variably displayable virtual keypad, comprising a mobile device having a screen on which is displayable selected content and a memory device; a plurality of holographic projectors housed in said mobile device for generating, from image generating data retrievable from said memory device, a virtual keypad appearing to be free-floating and spaced from said screen; and an input identification unit for identifying a virtual key pressing operation performed in conjunction with said generated virtual keypad, determining which key of said virtual keypad has been virtually pressed, and transmitting an input command in response to said virtual key pressing operation by which said displayed content is modifiable.

By using the term “keypad” it is meant to include any type of virtual keyboard, in which keys are generated as an array of 3-D holographic images, including numerical keys, textual keys, functions keys, gaming keys, icons and symbol keys of any size, shape and color. In one aspect, the generated keys in the keypad are 3-D keys with depth perception and appearance.

In one embodiment, the proposed system for generating and controlling a variably displayable virtual keypad, is implemented in an IVI (In-Vehicle Infotainment) system.

The present invention is also directed to a system for generating and controlling a variably displayable virtual user interface, comprising an electronic device having a screen on which is displayable selected content and a memory device; a plurality of holographic projectors housed in said device for generating, from image generating data retrievable from said memory device, a virtual user interface appearing to be free-floating; and an input identification unit for identifying a virtual key pressing operation performed in conjunction with said generated virtual user interface, determining which key of said virtual user interface has been virtually pressed, and transmitting an input command in response to said virtual key pressing operation by which said displayed content is modifiable, wherein one or more of said holographic projectors which were not activated to generate said virtual keypad are activatable in response to said virtual key pressing operation, to display visual feedback independently of said virtual keypad and generally aligned with said virtually pressed key.

The present invention is also directed to a system for generating and controlling a variably displayable virtual user interface, comprising an electronic device having a screen on which is displayable selected content and a memory device; a plurality of holographic projectors housed in said device for generating, from image generating data retrievable from said memory device, a virtual user interface appearing to be free-floating; an input identification unit for identifying a virtual key pressing operation performed in conjunction with said generated virtual user interface, determining which key of said virtual user interface has been virtually pressed by an initiating finger, and transmitting an input command in response to said virtual key pressing operation by which said displayed content is modifiable; and a plurality of ultrasonic transducers housed in said device for generating a focused ultrasonic beam propagatable to said initiating finger prior to being separated from said virtually pressed key in response to said virtual key pressing operation, to provide tactile feedback as indication to which key has been virtually pressed.

As referred to herein, a “virtual key pressing operation” also includes a virtual interfacing operation with an image appearing to be an object of the virtual user interface.

In one embodiment, the virtual keypad is generated when the electronic device lacks a screen.

The present invention is also directed to a system for generating and controlling a variably displayable virtual keypad, comprising a mobile device having a screen on which is displayable selected content, a microprocessor, a memory device and a home button; a plurality of holographic projectors housed in said mobile device for generating, from image generating data retrievable from said memory device, a virtual keypad appearing to be free-floating and spaced from said screen; a 3D camera housed in said mobile device proximate to said home button for capturing gestures of a user hand and for transmitting a signal which is indicative of gesture related data to said microprocessor; and an input identification unit for identifying a virtual key pressing operation performed in conjunction with said generated virtual keypad by means of said gesture related data, determining which key of said virtual keypad has been virtually pressed by means of instructions stored in said memory device, and transmitting an input command in response to said virtual key pressing operation by which said displayed content is modifiable.

The present invention is also directed to a method for performing a virtual key pressing operation, comprising the steps of generating a virtual keypad appearing to be free-floating by retrieving stored image generating data and operating a plurality of holographic projectors housed in a mobile device in accordance with said image generating data; tracking motion of an initiating finger; identifying a virtual key pressing operation when said initiating finger substantially coincides temporarily with an image plane of said virtual keypad; determining which key of said virtual keypad has been virtually pressed by means of instructions stored in a memory device of said mobile device; and transmitting an input command in response to said virtual key pressing operation.

### BRIEF DESCRIPTION OF THE DRAWINGS

In the drawings:

FIGS. 1A to 1C are a front view of three distinct displays, respectively, of an exemplary virtual keypad of the present invention, showing the variation in area of a key array between different displays;

FIG. 2 is a front view of a mobile device, schematically illustrating interaction with a generated virtual keypad;

FIG. 3 is a side view of the mobile device of FIG. 2, schematically illustrating interaction with a generated virtual keypad;

FIG. 4 schematically illustrates a plurality of virtual keys by which information is entered in one mode of operation;

FIG. 5 is a method for performing a virtual key pressing operation;

FIG. 6 is a schematic illustration of a mobile device based system for generating and controlling a virtual keypad, according to one embodiment of the present invention;

FIGS. 7-9 are a schematic illustration of three types of user specific gestures, respectively, by which visualization parameters of a generated virtual keypad may be changed;

FIG. 10 is a schematic illustration of a mobile device based system for generating and controlling a virtual keypad, according to another embodiment of the invention;

FIG. 11 is a front view of a mobile device used in conjunction with the system of FIG. 10, schematically illustrating interaction with a generated virtual keypad; and

FIG. 12 is a side view of the mobile device of FIG. 11, schematically illustrating interaction with a generated virtual keypad.

### DETAILED DESCRIPTION OF PREFERRED EMBODIMENTS

The present invention is a novel system for generating and controlling a virtual keypad for a mobile device that appears to be free-floating. The relative position of the free-floating keypad can be user selected, and the display can be toggled from one mode to another. The proposed system suggests a solution to one of the most critical elements in the future development of smartphones (and other mobile devices such as smart watches and other wearable devices), which is an advanced UI that is based on Holographic Virtual Keyboard and thereby, enhances the user experience.

While the surface area of a prior art keypad is constant and unchangeable in size, the surface area of the array of keys of the present invention can be toggled between different groups of images. By doing so, the displayed area of the keypad can be optimally utilized. That is, the exploited area dedicated for input keys is doubled (for toggling between two displays) or tripled (for toggling between three displays). In addition, a keypad region between keys that is not in use in one mode can be encompassed within the outline of a data transmitting key in another mode.

Furthermore, by using a UI that is based on Holographic Virtual Keypad, the generated virtual keypad is projected from the mobile device such that it is suspended in mid-air and spaced from the mobile device's screen, while the spacing and the size of the projected keypad determines the projection angle. This way, the projected keypad can exceed the size of the mobile device and can be enlarged according to the user's preferences, depending on the intensity and resolution of the projected keys. In fact, the size of the mobile device does not limit the appearance of the keypad like in conventional mobile devices. This greatly enhances and improves the user experience.

Several keypad modes can be user selected. A first mode may be one in which all keys display letters exclusively and a second mode may be one in which all keys display numerals exclusively. In additional modes, it is possible to add symbols (e.g., icons for activating applications), a dialing keypad, a gaming console and many other forms of virtual input keys. Similarly, a first mode may be one in which all keys display numerals exclusively and a second mode may be an alphanumeric display in which some keys display letters and some keys display numerals. Likewise, a first mode may be one in which all keys display numerals exclusively and a second mode may be one in which all keys display game functions exclusively. It will be appreciated that any other number of modes may be employed. It is also possible to select icons for activating functions in wearable devices Activity trackers, Smartwatches, Smartglasses, GPS watches, Healthcare monitors, pedometers and more. The wearable device may operate in communication with a smartphone, which may be used to display content or receive inputs from the user.

The appearance (shape, texture and color) of the keys in a given mode provides full freedom of look design to a designer of the device (which is a consumer product). Each key may have the same or a different configuration. Likewise the background which appears between two keys in a given mode can be adapted to the desired design. As a result, the key or keypad display configuration that appears may provide a fashionable variable display which is appealing to groups of specific users such as female and teenage users (also ethnic preferences).

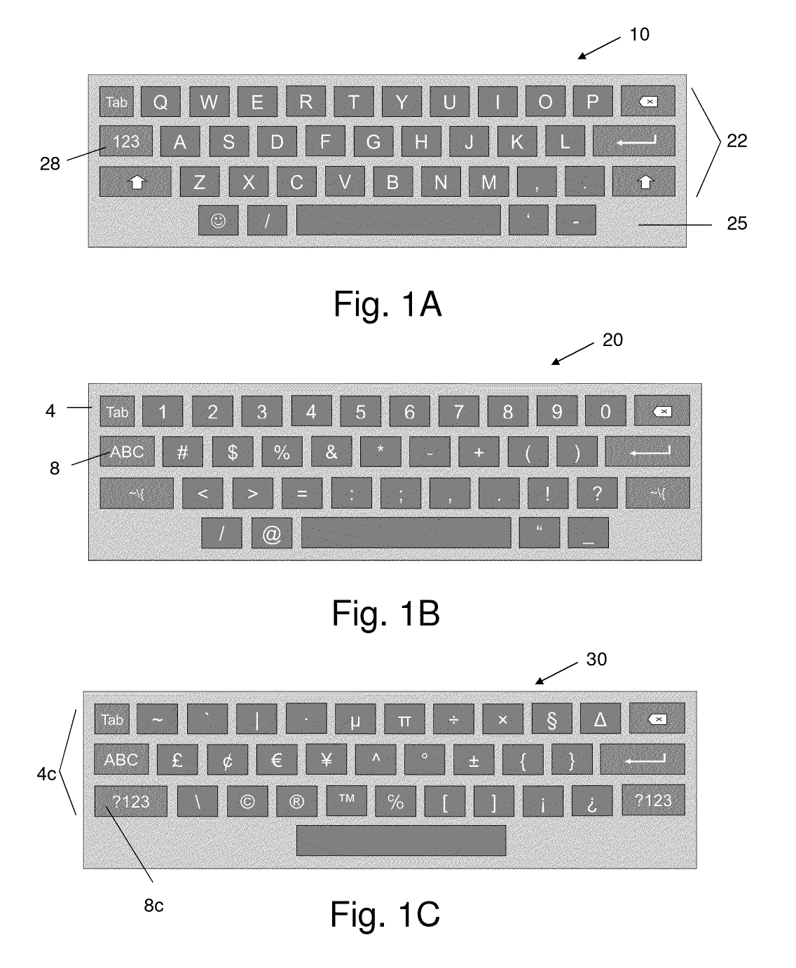

Display 10 shown in FIG. 1A is a display of letters in QWERTY arrangement having an array of virtual keys arranged in four columns, wherein region 22 consists of virtual keys for the 26 letters of the alphabet, a comma key, a shift key, and a period key, the mode key 28 for toggling from letters to a numeral display, and region 25 consisting of slash and space keys.

Display 20 shown in FIG. 1B is a numeric display having an array of virtual keys arranged in four rows, wherein region 4 consists of a virtual key for each of the 10 digits, the asterisk key, the pound key, the period key, and the exclamation mark key, and the mode key 8 for toggling the display to a display of letters.

Display 30 shown in FIG. 1C is a symbol display having an array of virtual keys arranged in three rows, wherein region 4c consists of a virtual key for each of the symbols, the lower row includes the space key, and the mode key 8c for toggling the display to a display of letters or to the numeric display.

Although the keypads of display 10, 20 and 30 are differently arranged, each virtual key is adapted to transmit a different signal to the microprocessor of the mobile device when pressed, to help define a data service to be performed. A discrete predetermined voltage is transmitted as a virtual key of the selected keypad is pressed.

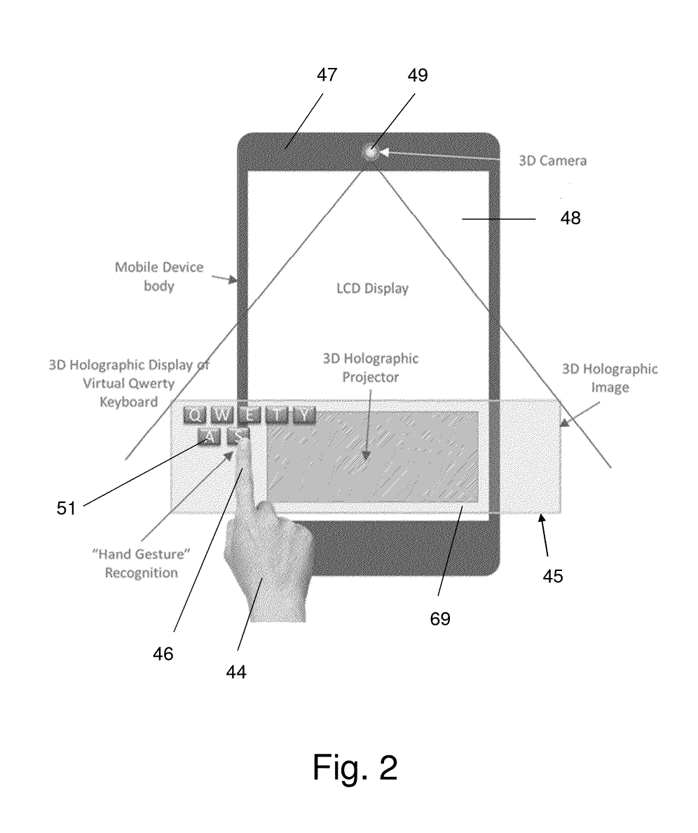

FIG. 2 schematically illustrates interaction with a generated virtual keypad 45. Virtual keypad 45 holographically generated by mobile device 47, e.g. a smartphone, is shown to be free-floating above a bottom region of its screen 48, such that the width of virtual keypad 45 is greater than that of screen 48. Portion 69 of virtual keypad 45 overlapping screen 48 may be transparent or semi-transparent, to allow the corresponding underlying portion of the screen to be visible. Screen 48 is shown to be a touchscreen with a high resolution LCD display, but it will be appreciated that mobile device 47 may also be equipped with any other screen well known to those skilled in the art such as 3D holographic display.

The technology for generating 3D holographic projected images is described for example in “Holographic Displays Coming to Smartphones”, IEEE Spectrum, http://spectrumleee.org/consumerelectronics/audiovideo/holographicdisplay scomingtosmartphones1/3, July 2014.

A 3D camera 49 captures the gestures of the user's hand 44, and particularly of finger 46, during interaction with virtual keypad 45. By knowing the spatial relation between the various keys 51 of virtual keypad 45 and movements of finger 46 that are characteristic of a key pressing operation, the mobile device processor is able to translate user gestures into input commands.

The keys 51 of virtual keypad 45 are preferably sufficiently spaced from each other to ensure that finger 46 will virtually press the correct key. Virtual keypad 45 may be generated with various optical effects to facilitate a virtual key pressing operation, such as a key border of a first virtual key appears to be sunken with respect to an adjacent virtual key or a virtual key is provided with a predetermined depth perception value.

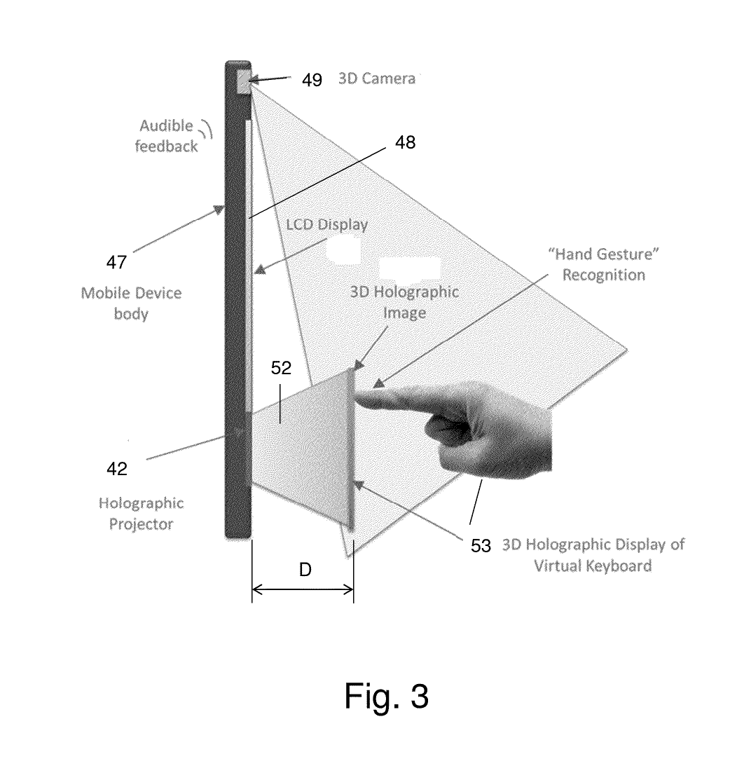

FIG. 3 illustrates a side view of virtual keypad 45, which is projected a distance D from the reference plane of screen 48 to the image plane 53. Distance D, is selected to be less than the length of the user's arm, to allow the mobile device to be comfortably held and to allow the virtual keypad to be comfortably viewed by the user. Holographic projector 42 mounted within the body of mobile device 47 generates reconstruction beam 52, which is generally conical as shown, to illuminate a selected hologram so that virtual keypad 45 will be visible.

In one embodiment of the invention, the keypad display is generated by a plurality of spaced holographic projectors 42, each of which is embedded in a different peripheral region of mobile device 47 to maximize the viewable surface area of screen 48.

The holograms are projected such that a first basic image corresponding to a first keypad mode is visible when a first reconstruction beam is generated and that a second basic image corresponding to a second keypad mode is visible when a second reconstruction beam is generated. The entire virtual keypad, for example as shown in FIGS. 1A-1C, may be generated by means of a corresponding hologram, following selection of a desired mode. Alternatively, a virtual keypad may be generated from a plurality of holograms. The technical considerations and design of such holograms, as well as the design of desired separation between the virtual keys, is well known in the art of holograms and need not described in the specification, for the sake of brevity. The holograms for different basic images may be provided on a same layer.

The displayed keys of virtual keypad 45 may have a one-to-one association with the keys that are normally used when interacting with mobile device 47.

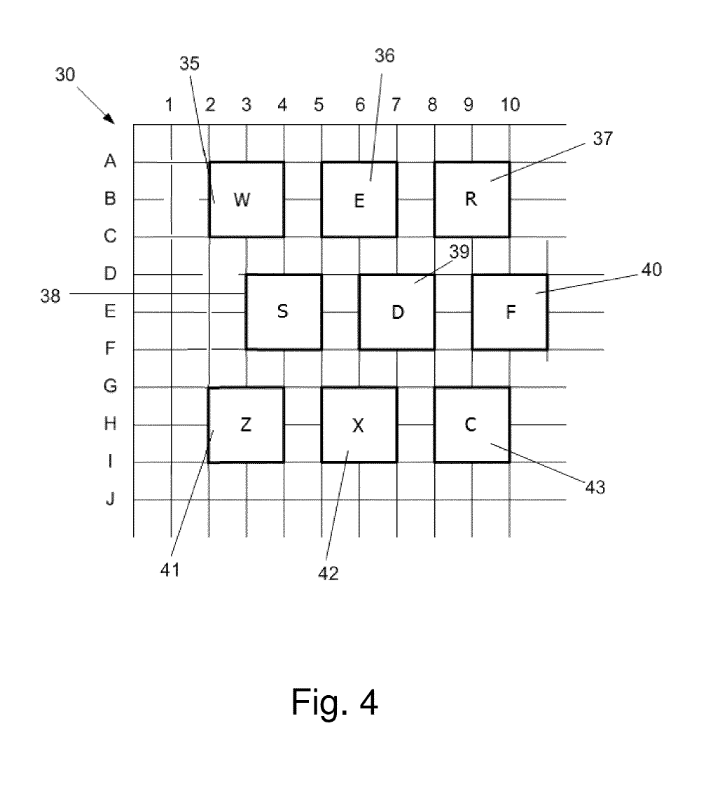

FIG. 4 schematically illustrates a portion of keypad display 30, to illustrate how a virtual key which has been pressed can be identified. Such identification is made possible by knowing the virtually displayed area of keypad display 30 and of each virtual key, and also the relative location of each virtual key within display 30. Since the 3D camera captures the instantaneous location of a finger during a virtual key pressing operation with respect to keypad display 30, which is associated with a grid of x-y coordinates, or even a grid of x-y-z coordinates, a region of display 30 that has been pressed may therefore be identified.

The coordinates of the illustrated keypad display portion are represented by x-coordinates 1-10 and by y-coordinates A-J. Virtual keys 35-43 corresponding to nine keys of display 20 of FIG. 1B, respectively, are shown in respect to the grid. The virtual keys for the letter mode are defined by the corresponding coordinates and are stored in the microprocessor. For example, letter E is delimited by the region defined by coordinates 5A, 7A, 5C and 7C. The microprocessor determines by means of software modules when an area within this region has been virtually pressed, and then transmits a signal to a data application that the letter E has been selected.

When an intermediate area between or bordering two key regions is pressed, an uncertainty arises as to which key region has been pressed. The microprocessor is provided with a software application that determines the highest probability of which key region has been desired to be pressed. For example, if an area between 4B and 5B has been virtually pressed, the microprocessor is uncertain as to whether key region W or key region E has been virtually pressed. The software application is generally based on other factors which help to decide which key the user actually intended to activate. In addition, whenever a key is virtually pressed and identified properly, an audible indication may be provided to the user, so as to notify him that his input has been concretely received.

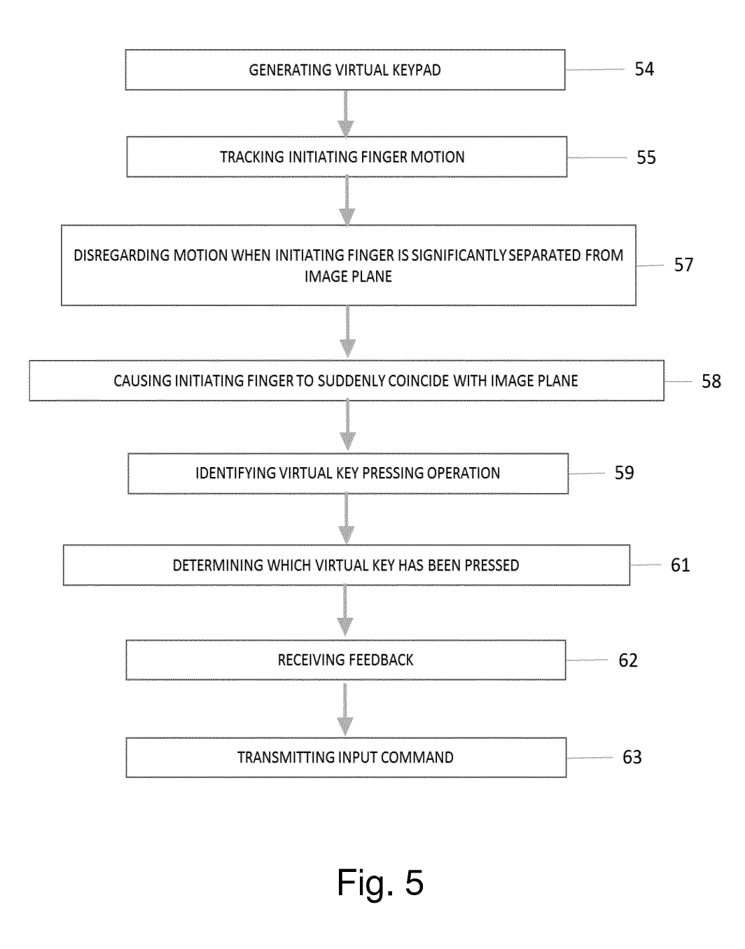

FIG. 5 illustrates a method for identifying a virtual key pressing operation. Following generation of the virtual keypad in step 54 the microprocessor tracks the motion of the initiating finger in the vicinity of the virtual keypad in step 55. The motion of the initiating finger is disregarded in step 57 when its distance from the image plane of the virtual keypad is greater than a first predetermined value for more than a first predetermined period of time. However, when the initiating finger suddenly and temporarily coincides with the image plane in step 58, i.e. its distance from the image plane of the virtual keypad is less than a predetermined distance for a predetermined period of time and then returns to be greater than the first predetermined value, the microprocessor interprets this motion as a virtual key pressing operation in step 59. An audible signal may be emitted following the virtual key pressing operation. The microprocessor determines which virtual key has been pressed in step 61 and subsequently transmits a corresponding signal to the data application to initiate an input command in step 63.

In step 62 the user may receive feedback, such as visual feedback, for example in the form of a change in color or size of a virtual key, in response to the virtual key pressing operation, or a display on the mobile device's screen, to know which key has been determined to have been virtually pressed. The mobile device is provided with means for cancelling the last input command if the visual feedback is indicative that an incorrect key has been found to be virtually pressed.

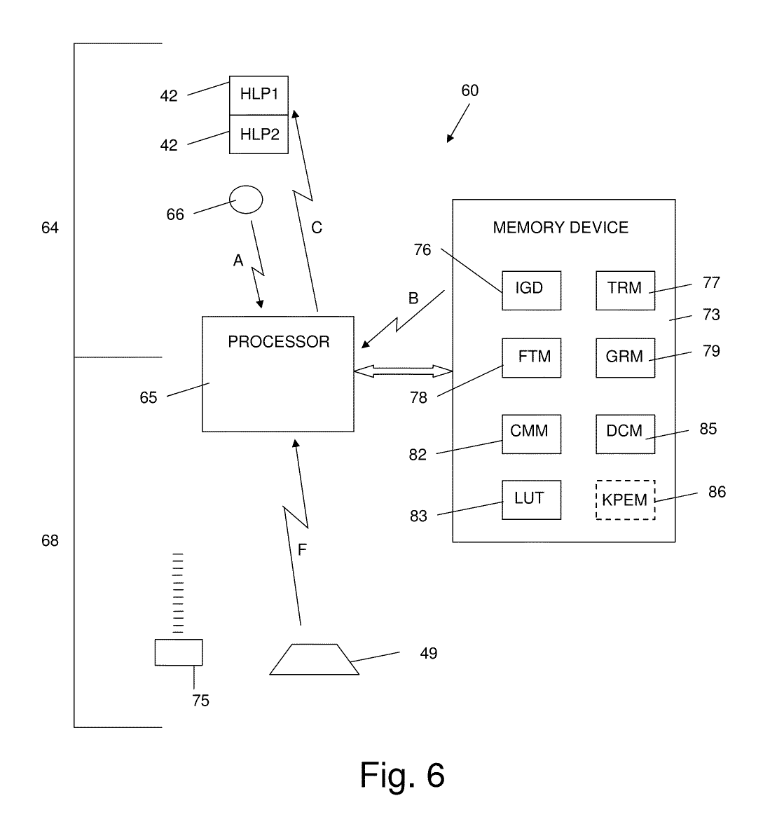

FIG. 6 schematically illustrates a mobile device based system for generating and controlling a virtual keypad, generally indicated by numeral 60, according to one embodiment of the present invention. System 60 comprises two units: a keypad generation unit 64 and an input identification unit 68.

Keypad generation unit 64 comprises one or more holographic projectors (HLP) 42, a memory device 73 in which is stored image generating data (IGD) 76 corresponding to each of a plurality of groups of predetermined basic images that are displayable on the virtual keypad, and microprocessor 65. A toggling device 66, which may be activated by interaction with the virtual keypad, generates an activation signal A which is transmitted to microprocessor 65. Microprocessor 65, in response to receiving activation signal A, retrieves the IGD 76 that corresponds to the user selected group of basic images from memory device 73 via signal B and then transmits a signal C indicative of the retrieved IGD to one or more selected holographic projectors 42, e.g. HLP1. The selected projectors in turn generate light beams in a predetermined fashion that permit a keypad related image to be displayed in conjunction with the holograms.

In response to the retrieved IGD, the virtual keypad is generated at a predetermined spatial relation with respect to the mobile device's screen functioning as the reference plane. A transparency rendering module (TRM) 77 stored in memory device 73 may determine which portion of the virtual keypad, if any, overlaps the reference plane and renders that portion transparent or semi-transparent, to maximize visibility of content displayed on the screen. Even though a portion of the virtual keypad has been rendered transparent or semi-transparent, nevertheless virtual keys generated at that overlapping portion remain visible to a certain extent and may be virtually pressed.

Input identification unit 68 comprises 3D camera 49 for capturing the gestures of the user's hand and for generating a depth map of the captured images. 3D camera 49 transmits signal F which is indicative of gesture related data to microprocessor 65. Microprocessor 65 translates the gesture related data into input commands by means of instructions stored in memory device 73. An emitter 75 may enunciate an audible signal following a virtual key pressing operation.

Stored in memory device 73 is a fingertip tracking module (FTM) 78 for extracting the relative location of a fingertip, from each frame captured by camera 49 and to thereby track finger movement, and a gesture recognition module (GRM) 79 that compares the tracked finger movement with known finger gestures so as to determine whether the recently determined gesture is characteristic of a key pressing gesture, or any other predetermined gesture. A coordinate matching module (CMM) 82 associates the relative coordinates of the virtual keypad with corresponding keys being displayed in conjunction with the selected group of basic images, or with relative coordinates of the mobile device's screen. If a key pressing gesture has been identified, microprocessor 65 is able to determine which key has been virtually pressed by means of CMM 82, and which corresponding command has been input by means of look-up table (LUT) 83 providing a predetermined correspondence between each displayed virtual key and an input command. A distortion correction module (DCM) 85 takes into account for any distorted images captured by camera 49.

The algorithms used by gesture recognition module (GRM) 79 for finger gesture recognition are well known to persons skilled in the art and are adapted to resolve complicated gestures such as when two or more fingers of the same hand are used or when using fingers of both hands for example, for typing.

A key pressing estimation module (KPEM) 86 may also be provided, for determining a highest probability of which virtual key has been desired to be pressed.

Although these modules are well known to those skilled in the art, and are therefore not described for sake of brevity, the interaction of the hardware components and software modules generates a virtually interactable keypad that has not been able to be achieved by prior art systems.

To provide visual feedback in response to the virtual key pressing operation, one or more holographic projectors HLP2 which were not activated to generate the virtual keypad are operated by microprocessor 65. After microprocessor 65 determined which key has been virtually pressed, IGD 76 corresponding to visual feedback data related to the virtually pressed key is retrieved from memory device 73 via signal B and then is retransmitted via signal C to one or more selected holographic projectors HLP2. The selected holographic projectors HLP2 in turn generate light beams in a predetermined fashion that permit the visual feedback to be displayed independently of the virtual keypad and generally aligned with the key that has been virtually pressed.

The visual feedback may be generated for a short period of time, to indicate which key has been virtually pressed. The visual feedback may be displayed on the same image plane as the virtual keypad such that the second hologram displaying the visual feedback is embedded in the virtual keypad. To differentiate images of the visual feedback from the virtual keypad, the light beams generating the second hologram may be of a significantly larger intensity or of a darker color than that generating the first hologram by which the virtual keypad is displayed. Alternatively, the visual feedback may be projected at a greater distance from the reference plane than the distance to which the image plane of the virtual keypad has been projected, to provide the sensation that the visual feedback is protruding from the virtual keypad.

The default position of the virtual keypad is above one longitudinal end of the mobile device's screen, while laterally protruding therefrom and covering approximately one-third of the screen, as shown in FIG. 2. At times the user is desirous of different virtual keypad visualization parameters. The visualization parameters may be changed by performing one or more user specific gestures, which have previously been stored in the memory device.

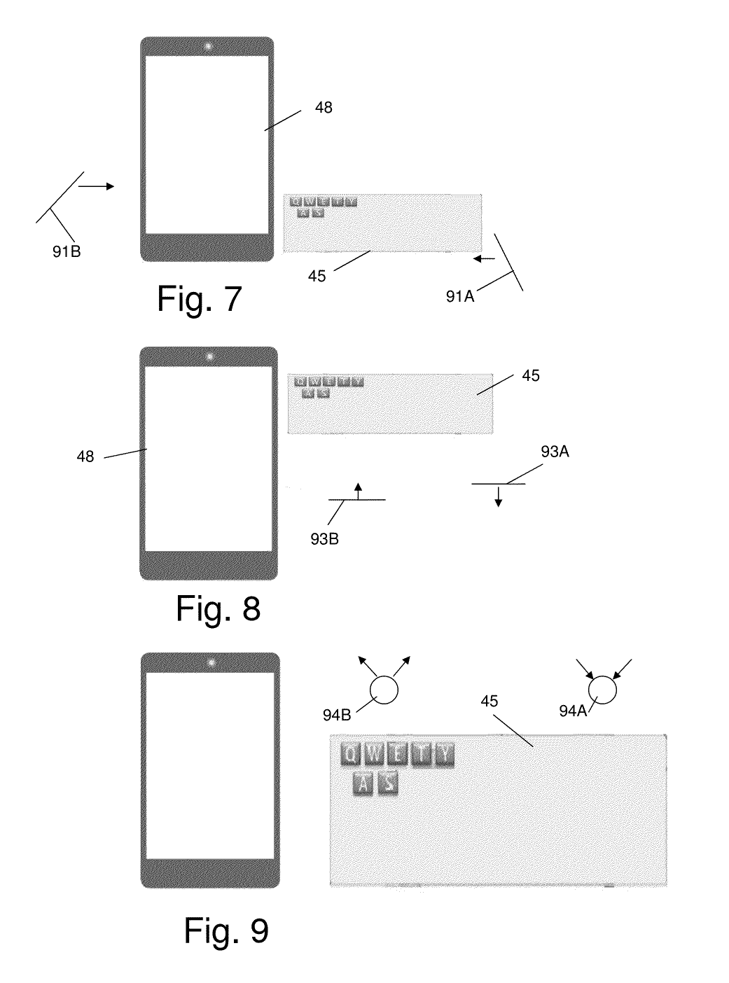

As shown in FIG. 7, a sideways hand gesture 91A or 91B is used to laterally change the position of virtual keypad 45 relative to mobile device screen 48. The sideways hand gesture may be performed when all fingers of a hand are vertically aligned one atop the other, gesture 91A used to move the virtual keypad leftwardly and gesture 91A to move it rightwardly. Each performance of the sideways hand gesture causes the virtual keypad to be displaced a predetermined discrete distance, up to a predetermined maximum lateral spacing from screen 48 to avoid distortion. After the 3D camera captures these gestures and transmits the corresponding data to the microprocessor, a new relative display position of the virtual keypad is stored in memory, to be used whenever the virtual keypad is to be displayed.

As shown in FIG. 8, a longitudinal hand gesture 93A or 93B is used to longitudinally change the position of virtual keypad 45 relative to mobile device screen 48. Each performance of the longitudinal hand gesture causes the virtual keypad to be displaced a predetermined discrete distance, up to a predetermined maximum longitudinal spacing from screen 48 to avoid distortion. After the 3D camera captures these gestures and transmits the corresponding data to the microprocessor, a new relative display position of the virtual keypad is stored in memory, to be used whenever the virtual keypad is to be displayed.

As shown in FIG. 9, a magnification correcting hand gesture 94A or 94B is used to change the viewed size of virtual keypad 45. Gesture 94A is performed when all fingers of a hand are substantially outstretched and then are bent in a direction towards the thumb, indicating that the size of the virtual keypad is to be reduced. Gesture 94B is performed when all fingers of a hand are positioned in the vicinity of the thumb and are then bent so as to be outstretched. Each performance of the magnification correcting hand gesture causes the size of the virtual keypad to be changed by a predetermined percentage, up to a predetermined maximum or minimum size to avoid distortion. The user may change the size according to his preferences after considering the resolution, light conditions and ease of activation.

After the 3D camera captures these gestures and transmits the corresponding data to the microprocessor, a new relative size of the virtual keypad is stored in memory, to be used whenever the virtual keypad is to be displayed.

Other user specific gestures may be used as well to change one or more virtual keypad related visualization parameters.

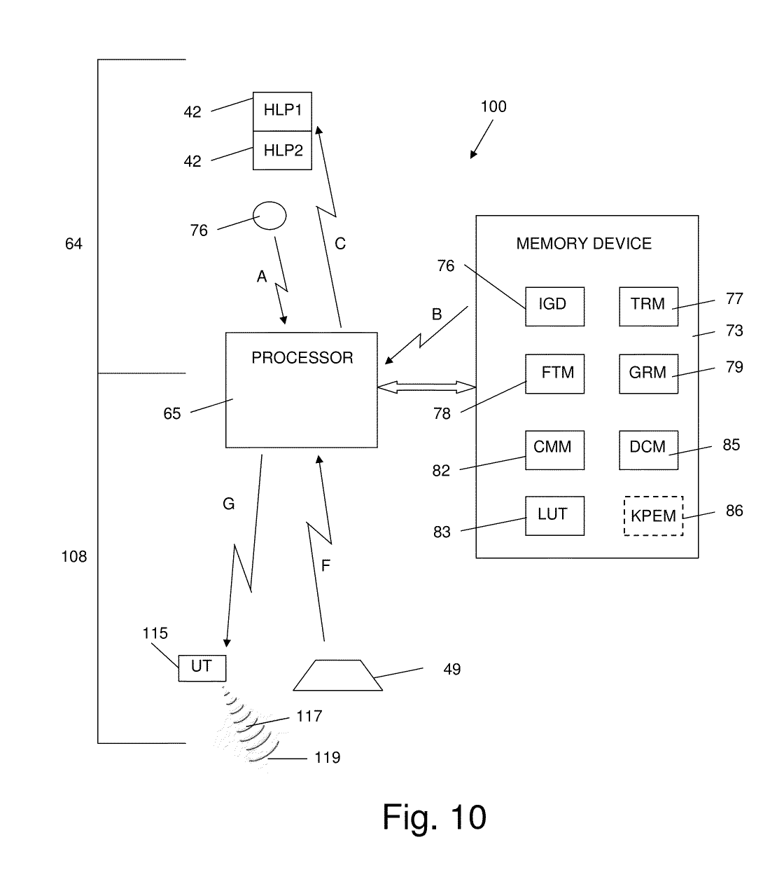

In another embodiment illustrated in FIGS. 10-12, the user receives tactile feedback in response to a virtual key pressing operation, to indicate to the user which key has been selected.

As shown in FIG. 10, input identification unit 108 of system 100 comprises an array of ultrasonic transducers (UT) 115 for generating an intense and focused acoustic beam 117 onto the initiating finger, and particularly the fingertip, during a virtual key pressing operation. The initiating finger experiences acoustic radiation pressure, or pressure which is proportional to the acoustic power of the generated ultrasonic beam 117, in a direction normal to the propagation direction of the beam. Such pressure which provides the sensation of physical contact as a result of the increase in atmospheric pressure experienced by the initiating finger when impinged by beam 117 is indicative to the user that the virtual key coinciding with the present location of the initiating finger has been pressed.

The phase delay and amplitude of the acoustic wave generated by each UT 115 are individually controlled by a command signal G transmitted by microprocessor 65. The signal G transmitted to each UT 115 of the array is carefully selected in order to control the spatial distribution of ultrasonic beam 117 by wave field synthesis, in order to generate a single focal point 119. The focused beam 117 is periodically transmitted, after a predetermined time interval has elapsed, in order to reduce power consumption.

The technology for generating a focused ultrasonic beam is described for example in “Focused Ultrasound for Tactile Feeling Display”, Iwamoto et al., the University of Tokyo, 2001 and in “Touchable Holography”, Hoshi et al., The University of Tokyo, 2006.

After microprocessor 65 determines which virtual key has been pressed by means of FTM 78, GRM 79, CMM 82 and DCM 85, a corresponding signal G is generated and transmitted to each UT 115 of the array, so that the initiating finger will be impinged by ultrasonic beam 115 before being removed from the selected virtual key and will receive a tactile feedback that is indicative of the virtual key pressing operation.

The other components of system 100 are identical to system 60 of FIG. 6, with the exception of the emitter, which emits an audible signal that is added to the tactile feedback.

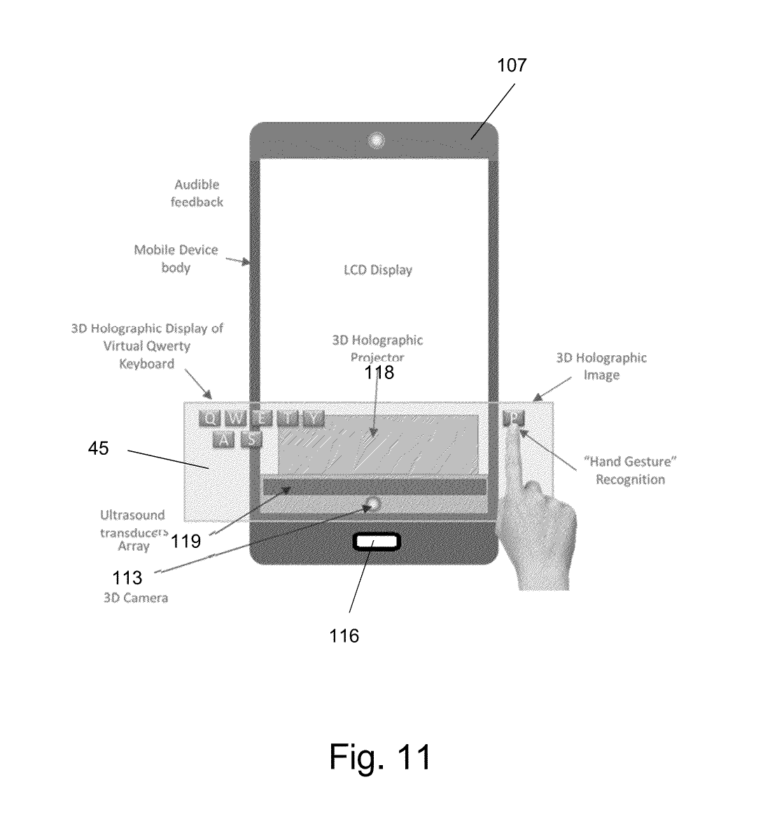

FIG. 11 schematically illustrates a front view of a mobile device 107 usable in conjunction with system 100. In this embodiment, mobile device 107 comprises a 3-D camera 113 embedded in a bottom portion of its housing, in the vicinity of the physically pressable home button 116. Fingertip tracking and gesture recognition are carried out much more accurately when 3-D camera 113 is positioned in close proximity to the user's hand.

Mobile device 107 also comprises a component 118 in which is housed an array of holographic projectors, and a component 119 in which is housed an array of ultrasonic transducers. Each of the holographic projectors and ultrasonic transducers is in data communication with the microprocessor.

Components 118 and 119 may be positioned at a location of mobile device 107 that is normally covered by virtual keypad 45, and therefore the use thereof is not at the expense of viewable screen area. Likewise 3-D camera 113 may be positioned at a location of mobile device 107 that is normally covered by virtual keypad 45.

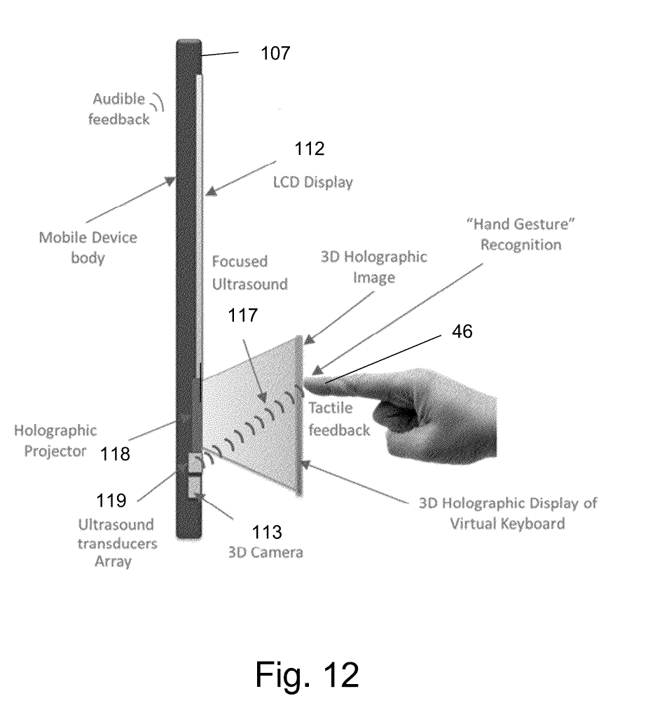

FIG. 12 schematically illustrates a side view of mobile device 107, showing the relative location of screen 112, 3D camera 113, array 118 of holographic projectors and array 119 of ultrasonic transducers, and also the impingement of initiating finger 46 by focused ultrasonic beam 117 during a virtual key pressing operation.

As can be appreciated from the foregoing description, the system of the present invention generates a virtual free-floating mobile device keypad with which a user is able to interface for the reliable and accurate transmission of input commands, while receiving feedback as to which key has been virtually selected.

It will be appreciated that the system is also applicable to any other virtual free-floating user interface.

The proposed system for generating and controlling a variably displayable virtual keypad may be implemented in an IVI (In-vehicle Infotainment) system, which consists of hardware devices installed into automobiles, to provide audio and/or audio/visual entertainment, as well as automotive navigation. Currently, the IVI systems are evolving from purpose-specific devices into connected, upgradeable and integrating platforms for running more applications, with internet services that keep drivers connected to the outside world.

An IVI system has wideband internet connectivity (e.g., via a cellular network) and is adapted to provide content over a display screen (generally in the form of a dashboard). The IVI system requires input means for allowing interaction with the driver/passenger. Since the infotainment and connectivity technologies become embedded in the cars dashboard itself, the system proposed by the present invention allows interactions with the IVI system via a 3-D virtual keypad using hand gestures of the driver as the inputs, thereby minimizing driver distractions and improving driving safety.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A system for generating and controlling a variably displayable virtual keypad, comprising a mobile device having a screen on which is displayable selected content and a memory device; a plurality of holographic projectors housed in said mobile device for generating, from image generating data retrievable from said memory device, a virtual keypad appearing to be free-floating and spaced from said screen; and an input identification unit for identifying a virtual key pressing operation performed in conjunction with said generated virtual keypad, determining which key of said virtual keypad has been virtually pressed, and transmitting an input command in response to said virtual key pressing operation by which said displayed content is modifiable.

2. The system according to claim 1, wherein the input identification unit comprises a 3D camera for capturing gestures of a user hand and for transmitting a signal which is indicative of gesture related data to a microprocessor for translating said gesture related data into the input command by instructions stored in the memory device.

3. The system according to claim 2, wherein the instructions are retrievable from one or more modules selected from the group of a fingertip tracking module, a gesture recognition module, a coordinate matching module, a look-up table, a distortion correction module, and a key pressing estimation module.

4. The system according to claim 2, wherein the microprocessor is operable to generate feedback in response to the virtual key pressing operation to indicate which key has been virtually pressed.

5. The system according to claim 2, wherein the microprocessor is operable to modify a visualization parameter of the generated virtual keypad in response to performance of one or more user specific gestures.

6. A system for generating and controlling a variably displayable virtual user interface, comprising an electronic device having a screen on which is displayable selected content and a memory device; a plurality of holographic projectors housed in said device for generating, from image generating data retrievable from said memory device, a virtual user interface appearing to be free-floating; and an input identification unit for identifying a virtual key pressing operation performed in conjunction with said generated virtual user interface, determining which key of said virtual user interface has been virtually pressed, and transmitting an input command in response to said virtual key pressing operation by which said displayed content is modifiable, wherein one of said holographic projectors which were not activated to generate said virtual keypad are activatable in response to said virtual key pressing operation, to display visual feedback independently of said virtual keypad and generally aligned with said virtually pressed key.

7. A system for generating and controlling a variably displayable virtual user interface, comprising an electronic device having a screen on which is displayable selected content and a memory device; a plurality of holographic projectors housed in said device for generating, from image generating data retrievable from said memory device, a virtual user interface appearing to be free-floating; an input identification unit for identifying a virtual key pressing operation performed in conjunction with said generated virtual user interface, determining which key of said virtual user interface has been virtually pressed by an initiating finger, and transmitting an input command in response to said virtual key pressing operation by which said displayed content is modifiable; and a plurality of ultrasonic transducers housed in said device for generating a focused ultrasonic beam propagatable to said initiating finger prior to being separated from said virtually pressed key in response to said virtual key pressing operation, to provide tactile feedback as indication to which key has been virtually pressed.

8. A system for generating and controlling a variably displayable virtual keypad, comprising a mobile device having a screen on which is displayable selected content, a microprocessor, a memory device and a home button; a plurality of holographic projectors housed in said mobile device for generating, from image generating data retrievable from said memory device, a virtual keypad appearing to be free-floating and spaced from said screen; a 3D camera housed in said mobile device proximate to said home button for capturing gestures of a user hand and for transmitting a signal which is indicative of gesture related data to said microprocessor; and an input identification unit for identifying a virtual key pressing operation performed in conjunction with said generated virtual keypad by said gesture related data, determining which key of said virtual keypad has been virtually pressed by instructions stored in said memory device, and transmitting an input command in response to said virtual key pressing operation by which said displayed content is modifiable.

9. A method for performing a virtual key pressing operation, comprising the steps of generating a virtual keypad appearing to be free-floating by retrieving stored image generating data and operating a plurality of holographic projectors housed in a mobile device in accordance with said image generating data; tracking motion of an initiating finger; identifying a virtual key pressing operation when said initiating finger substantially coincides temporarily with an image plane of said virtual keypad; determining which key of said virtual keypad has been virtually pressed by means of instructions stored in a memory device of said mobile device; and transmitting an input command in response to said virtual key pressing operation.

10. The system according to claim 1, wherein the mobile device is a wearable device selected from the group of Activity trackers, Smartwatches, Smartglasses, GPS watches, Healthcare monitors and pedometers.

11. The system according to claim 10, wherein the wearable device operates is being in communication with a smartphone.
